(19) United States
(12) Patent Application Publication
(10) Pub. No.: US 2003/0186685 A1
(43) Pub. Date: Oct. 2, 2003

(54) Module for generating circuits for analysing bit strings inside data cells, method for generating this type of circuit and relative circuit

(76) Inventors: Gianmario Bollano, Torino (IT); Serafino Claretto, Torino (IT); Maura Turolla, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/343,313

(22) PCT Filed: Jan. 16, 2001
(86) PCT No.: PCT/IT01/00018

(30) Foreign Application Priority Data
Aug. 1, 2000 (IT) TO00A000762

(51) Int. Cl. H04M 11/10

(52) U.S. Cl. 455/412; 455/414

(57) ABSTRACT

This invention refers to a module 10 for generating integrated circuits suitable for analysing and validating bit strings inside telecommunications data cells, to the method for defining the structure and characteristics of such module and the integrated circuits that can be generated and to the integrated circuit that can be obtained with such module 10. The module 10, called parser, is parametric and makes it possible to generate parser circuits for many protocols because of such characteristic; the module 10, also, makes it possible, by means of a module REGFILE_2OUT 12, to generate programmable parser circuits and, by means of a module LOGIC_OPER 22 that can generate several analysis and validation devices, to execute in parallel bit string analysis inside telecommunications data cells.

### TECHNICAL FIELD

This invention refers to a module for generating circuits for analysing bit strings inside data cells, to the method for generating this type of circuit and to the relative circuit.

In particular, this invention refers to a module for generating integrated circuits suitable to analyse and validate bit strings inside telecommunications data cells, to the method for defining the structure and the characteristics of such module and of the circuits that can be generated and to an integrated circuit that can be obtained with such module.

### BACKGROUND ART

Designing integrated circuits by using high-level description languages such as the Very High Speed Integrated Circuit Hardware Description Language (VHDL), for instance, is known in technique. An integrated component having the characteristics defined by means of the high-level language can be obtained from a VHDL description with such design technique and by using suitable Silicon Compilers.

VHDL descriptions of predefined functions are also known to be capable of generating module libraries called Intellectual Property or IP Libraries, which permit the implementation of very complex electronic circuits, such as Systems On Chip (SOC) for instance.

IP library modules feature the special characteristic of being suitable for use in designing several electronic circuits thanks to the fact that before compilation on silicon they can be “specialized” as regards interface parameters with other electronic devices or modules by attributing given values to variables or parameters pre-defined during design phase.

The telecommunications IP module and corresponding circuits for analysing the presence of one or more bit strings inside a data cell are taken as a reference for the purposes of this invention. This type of module and corresponding circuits, hereinafter referred to as “parser”, are suitable to validate data cells by associating validation information to individual cells and are transparent to data cell stream, in the sense that output data are identical to input data.

Modules and their corresponding parser circuits are generally used as analysis and validation tools for various telecommunication protocols, such as MPEG II, DECT and the like. The data cell of MPEG II transport stream protocol must for instance contain the following information:

binary string 0100 0111 (HEX 47) in the first byte (position 0);

the first part of the Packet IDentifier (PID) in the last 5 bits of the second byte (position 1) and;

the second part of the PID in the third byte (position 2).

The function of a parser circuit for the MPEG II transport stream protocol could be to identify inside the data cell:

the value HEX 47 with a first control on the first byte or on position 0;

the contents of the first part of the PID in the last 5 bits of the second byte with a second control; and

the contents of the second part of the PID on the third byte or position 2 with a third control.

The above sequence of operations is of course different from the one required to identify other information inside the same protocol or similar information in a different protocol. Known parser modules are therefore generally described so as to be specialized on silicon to obtain a circuit suitable to analyse only one type of protocol and to perform only one predefined function.

Known parser modules are in other words suitable to be attached rigidly (or “wired”) to the function and protocol. After compilation on silicon, a known parser module can for instance allow to implement a circuit suitable to only perform one control by equivalence on a well-defined field of a predefined word of the data cell of a determined protocol.

In essence, known parser modules present severe limitations, particularly for the telecommunications field, since:

they can be compiled on silicon to obtain a circuit suitable to perform only one type of function; and

can be compiled on silicon to obtain a circuit suitable to manage only one type of protocol.

The availability of a module for generating parser circuits that can be used with the same protocol for validation functions that may be different or changed due to changes in specifications or maintenance reasons would of course be useful.

The possible use of the same parser circuit for different types of protocols would also be very important.

The above limitations cannot however be overcome with known parser modules and require the use of various types of parser circuits in electronic systems to perform different functions with the same protocol or to perform the same function with different protocols.

### DISCLOSURE OF THE INVENTION

Object of this invention is to indicate the methodologies for describing flexible parser modules such as to obtain flexible integrated parser circuits suitable for being used with different functions and protocols.

According to the object, this invention proposes a parser module as at claim 1, a method for generating such circuits as at claim 5, and a parser circuit as at claim 9.

The parser module according to the invention has the advantage of being parametric and making it possible to generate programmable circuits adaptable to various types of protocols.

The advantage of the method according to the invention consists in making it possible to essentially generate a wide range of telecommunications parsers and therefore giving an ideal tool for defining this type of module in an IP library for creating SOC or electronic circuits.

The parser circuit according to the invention has the advantage of being programmable from time to time by means of a control unit and therefore of being suitable to selectively manage either different functions with the same protocol or similar functions with different protocols.

### BRIEF DESCRIPTION OF DRAWINGS

This and other characteristics of this invention will be clarified by the following description of a preferred embodiement, given as a non-limiting example, with the support of the attached drawings, in which:

FIG. 1 represents a flow diagram for module and circuit generation according to the invention;

FIG. 2 represents the architecture of the module and circuit obtainable with the flow diagram of FIG. 1;

FIG. 3a represents an example of bit strings inside a cell according to the MPEG II Transport Stream protocol; and

FIG. 3b represents an example of instructions for programming a parser circuit obtained with the flow diagram of FIG. 1 to analyse the bit strings of FIG. 3a.

### BEST MODE FOR CARRYING OUT THE INVENTION

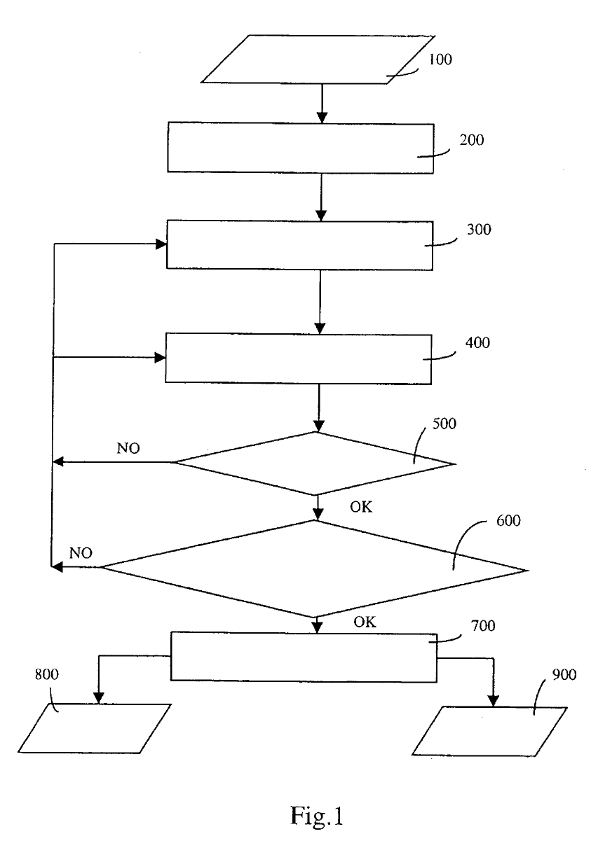

FIG. 1 shows the flow diagram for the design of a parametric parser module and relative programmable parser circuits according to the invention.

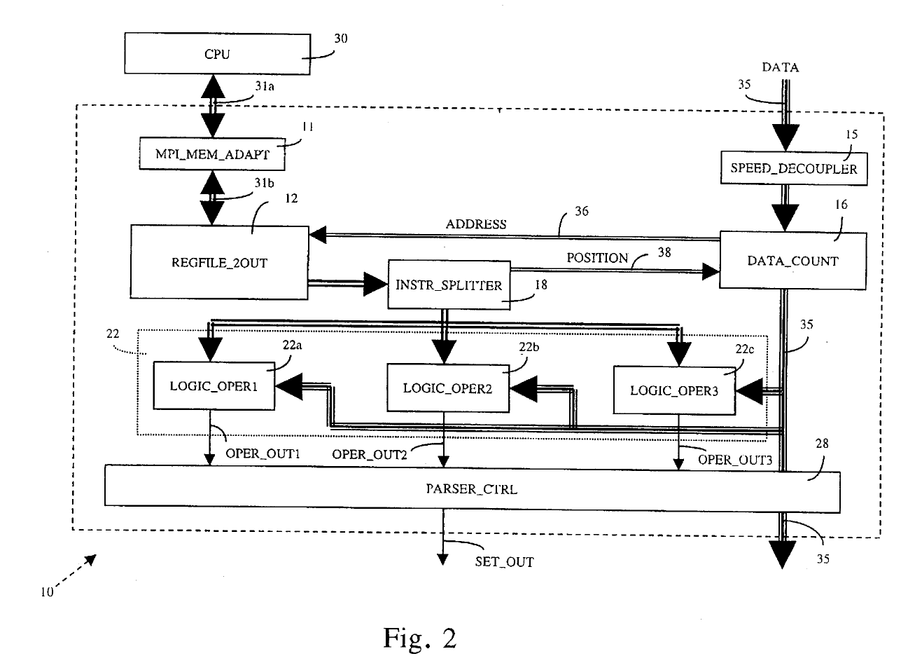

The general specifications of parser circuits are defined at an initial step 100; in particular, various telecommunications protocols and various types of possible analyses on the data strings of such protocols are examined, for instance. As completion of step 100, a general architecture of parser module 10 is generated according to this invention (FIGS. 1 and 2); the module architecture is described hereafter. In accordance with such architecture, parser module 10 comprises a programmable module (REGFILE_{—}2OUT) 12 and a first interface module (MPI_MEM_ADAPT) 11, of known type, associated to the REGFILE_{—}2OUT 12 by means of a programming instructions channel (bus 31b), suitable to adapt data exchange between a known type external Central Processing Unit (CPU) 30 and the REGFILE_{—}2OUT 12 itself. As will be described in detail further on, the REGFILE_{—}2OUT 12 is suitable to store in several registers the programming instructions transmitted by the CPU 30 through a bus 31a of the same width as the bus 31b and retransmit such programming instructions to the CPU 30 after storage to check consistency of instructions received with those stored.

Parser module 10 also comprises a known type input data module (DATA_COUNT) 16, and a second interface module (SPEED_DECOUPLER) 15, of known type, associated to the DATA_COUNT 16 by means of a data bus 35 and suitable to keep the input data stream on bus 35 synchronized with the DATA_COUNT 16 by using a synchronisation signal or clock having a frequency at least double that of input data frequency. The DATA_COUNT 16, of known type, is suitable both to keep the stream of input data cells under control and to transmit addresses to the REGFILE_{—}2OUT 12 registers by means of an address channel 36, so that based on the addresses (ADDRESS) transmitted by DATA_COUNT 16 to REGFILE_{—}2OUT 12 the programming instructions stored inside the REGFILE_{—}2OUT 12 registers are executed on given data cell bit strings. For the sake of completeness, it should be added that writing by the CPU 30 on the REGFILE_{—}2OUT 12 is performed by using an initial addressing that takes account of the width of the programming bus 31b, while the DATA_COUNT uses a second addressing that considers the whole programming instruction, generally of greater width than the programming bus 31b. REGFILE_{—}2OUT 12 is therefore a module featuring two addressing modes: an initial one consistent with the programming bus 31b and a second one consistent with the width of the complete programming instruction as will be described in detail further on.

The general architecture of parser module 10 also comprises one or more analysis modules (LOGIC_OPER) 22, three of which are indicated in the example, namely LOGIC_OPER1 22a, LOGIC_OPER2 22b and LOGIC_OPER3 22c associated to the DATA_COUNT 16 and to the REGFILE_{—}2OUT 12. Each LOGIC_OPER1-3 (22a, 22b, 22c), as will be described in detail further, is suitable to perform the analysis of data strings inputted from DATA_COUNT 16 on the basis of the programming instructions stored in REGFILE_{—}2OUT 12.

Parser module 10 also comprises a known type instruction splitter module (INST_SPLITTER) 18 interposed between REGFILE_{—}2OUT 12 and the LOGIC_OPER 22 modules and suitable to distribute to the LOGIC_OPER 22 modules the corresponding programming instructions to be applied to the data cell bit strings, as will be described in detail further on. The INSTR_SPLITTER 18 is also connected to the DATA_COUNT 16 by means of a data channel for pointing to the bit string position (position bus) 38 and is suitable to use the position bus 38 to transmit the position (POSITION) of the data cell bit string to analyse.

Lastly, parser module 10 comprises a known type state machine module (PARSER_CTRL) 28, operating as a state machine unit and suitable to receive in input both data from the DATA_COUNT 16 and groups of control signals, respectively OPER_OUT1, OPER_OUT2, OPER_OUT3, from the corresponding LOGIC_OPER1 22a, LOGIC_OPER2 22b, LOGIC_OPER3 22c, and to transparently output the data and, in synchronism with the data, corresponding groups of SET_OUT signals, indicative of the result of the analysis completed on the data cell strings.

After definition of parser module 10 architecture, its degree of programmability is defined in a second step 200 (FIGS. 1 and 2). This step 200, one of the characteristic elements of the invention, is targeted at identifying and defining so-called generic parameters. Such parameters make it possible to obtain several parser circuits from one parser module 10 and allow one parser circuit obtained from parser module 10 according to the invention to perform different analyses on the same or different protocols. In essence, generic parameters (generics) and the possible values such generics can have are defined in step 200. Several parser circuits can thus be obtained from one description in VHDL language, for instance. This step is essential for the invention as it is targeted at defining the global flexibility of parser module 10 for its use in an IP library.

Table 1 hereunder lists the generics defining flexibility as above and significant for the invention.

TABLE 1

| | | Number | Default |
|---|---|---|---|
| Generic name | Function | of bits | values |
| PROG_WIDTH | Programming bus 31 | 4, 8, | 8 |
| | width between CPU 30 | 16, 32 | |
| | and | | |
| | REGFILE_2OUT 12 | | |
| DATA_WIDTH | Data bus 35 width | 4, 8, | 8 |
| | | 16, 32 | |
| MAX_SETS | Maximum number of | 1-8 | 2 |
| | checks | | |
| MAX_OPER | Maximum number of | | |
| | concurrent operations; | 1-8 | 3 |
| | corresponds to the | | |
| | number of | | |
| | LOGIC_OPER (22) | | |
| MAX_PROG_WORDS | Maximum number of | Depends | 8 |
| | programming registers in | on | |
| | REGFILE_2OUT 12 | previous | |
| | | parameters | |

For the sake of completeness, it should be highlighted that the programming instruction width (number of bits) is not defined with a generic parameter; this because, similarly to MAX_PROG_WORDS, it depends on the number and on the size (number of bits) of parameters which estabilish the programming instruction.

The individual modules making up parser module 10 are developed and described, in VHDL language for instance, in a third step 300, a further characteristic element of the invention. For the sake of completeness, the description comprises the sources of significant modules for implementing the invention and a list of generally known type modules. In particular, the sources so-called “ENTITY”, “ARCHITECTURE” and “INSTANTIATED” of significant modules are given, such terms being certainly known to technicians aware of the formalisms to be used for describing modules in VHDL language.

REGFILE_2OUT MODULE

1] REGFILE_2OUT INSERTED INTO THE PARSER ARCHITECTURE
I_REGFILE_2OUT : REGFILE_2OUT
-- ASSOCIATION OF GENERAL PARAMETERS AND INPUTS/OUTPUTS TO MODULE
-- PARAMETERS AND INPUTS/OUTPUTS

generic map (

NWORDS => MAX_PROG_WORDS,

NBITS => PROG_WIDTH,
NBITSOUT2 => INSTR_WIDTH,
WENB_VAL => 0,
RSTMODE => 0)

port map (

CLK => CK_P3,
N_RST => RSTN,
RDATA1 => RDATA_PROG,
RDATA2 => RDATA_INSTR,
RADDR1 => ADDR_P3,
RADDR2 => RADDR_INSTR,
WADDR => ADDR_P3,
WDATA => WDATA_PROG,
WENB => WEN_P3);

2] REGFILE_2OUT ENTITY
--------------------------------------------------------------------------------
-- Module: PARSER
-- VIP library (TM)
-- (C) Copyright by CSELT S.p.A 1999
-- File name: regfile_2out.vhd
-- Purpose:
-- Synthesis: synthesizable
---------------------------------------------------------------
library IEEE ;

use IEEE.std_logic_1164.all ;

library PARSER_REF;

use PARSER_REF.PARSER_REF_PACK.all;

library PACKAGES_REF;

use PACKAGES_REF.VIP_ARITH.all;

entity REGFILE_2OUT is
-- PARAMETER DEFINITION

generic (

| | |
|---|---|
| NWORDS | : integer := 16; |
| NBITS | : integer := 16; |

| | |
|---|---|
| NBITSOUT2 | : integer := 64; |
| WENB_VAL | : integer := 0; |

-- 0 = WENB active LOW; 1 = WENB active HIGH

| | |
|---|---|
| RSTMODE | : integer := 0 -- 0 = Asynch; 1 = Synch; |

);

-- DEFINITION OF MODULE INPUTS AND OUTPUTS

port (

| | |
|---|---|
| CLK | : in std_ulogic ; |
| N_RST | : in std_ulogic ; |

| | |
|---|---|
| RDATA1 | : out std_ulogic_vector ( NBITS - 1 downto 0 ); |
| RDATA2 | : out std_ulogic_vector ( NBITSOUT2 - 1 downto 0 ); |
| RADDR1 | : in std_ulogic_vector ( LOG2CP( NWORDS ) - 1 downto 0 ); |
| RADDR2 | : in std_ulogic_vector ( LOG2CP((NWORDS*NBITS)/NBITSOUT2 ) |

- 1 downto 0 );

| | |
|---|---|
| WADDR | : in std_ulogic_vector ( LOG2CP( NWORDS ) - 1 downto 0 ); |
| WDATA | : in std_ulogic_vector ( NBITS - 1 downto 0 ); |

WENB : in std_ulogic

);

end REGFILE_2OUT ;
3] REGFILE_2OUT ARCHITECTURE
-- Module: PARSER
-- VIP library ™
-- © Copyright by CSELT S.p.A 1999
-- File name: regfile_2out_rtls_mux.vhd
-- Purpose:
-- Synthesis: synthesizable
-- CONSTANT OR SIGNAL DEFINITION
library IEEE ;

use IEEE.std_logic_1164.all ;
use IEEE.std_logic_arith.all ;

library PACKAGES_REF;

use PACKAGES_REF.VIP_ARITH.all;

architecture RTLS_MUX of REGFILE_2OUT is

constant SYNC_RESET : boolean := (RSTMODE = 1);

constant WEN_LOGIC_VAL : std_ulogic_vector(0 downto 0) :=

std_ulogic_vector(conv_unsigned(WENB_VAL.1));

type RF_REG_TYPE is

array (0 to NWORDS-1) of std_ulogic_vector (NBITS-1 downto 0);

signal RF_REG, RF_REG_INP : RF_REG_TYPE ;
signal OUT2_WORDS : std_ulogic_vector(NBITS*NWORDS-1 downto 0);
signal RDATA1_INP, RDATA1_REG : std_ulogic_vector(NBITS - 1 downto

0);
begin
-- DESCRIPTION OF COMBINATORY FUNCTIONS AND ASSOCIATIONS OF SIGNALS
-- THAT WILL BE IMPLEMENTED WITH DISCRETE LOGIC OR DIRECT CONNECTION

RDATA1 <= RDATA1_REG;
RDATA1_INP <= RF_REG( CONV_INTEGER( unsigned(RADDR1) ) );
MERGE_OUT2: for index in 0 to NWORDS-1 generate

OUT2_WORDS(NBITS*NWORDS-1-index*NBITS downto NBITS*(NWORDS-1)-

index*NBITS ) <=

RF_REG(index);

end generate MERGE_OUT2;
RDATA2 <= MUX_INVERT(OUT2_WORDS,RADDR2,NBITSOUT2);

-- PROCESSES FOR PROGRAMMABLE REGISTER DEFINITION
AR_SEQ : if not SYNC_RESET generate
-- PROCESS NUMBER 1
RF_SEQ : process (CLK, N_RST)
begin

if N_RST = ‘0’ then

RF_REG <= ( others => ( others => ‘0’ ) );

elsif (CLK'event and CLK = ‘1’) then

RF_REG <= RF_REG_INP;

end if ;

end process RF_SEQ ;

end generate AR_SEQ ;
SR_SEQ : if SYNC_RESET generate

-- PROCESS NUMBER 2
RF_SEQ : process (CLK, N_RST)
begin

if (CLK'event and CLK = ‘1’) then

if N_RST = ‘0’ then

RF_REG <= ( others => ( others => ‘0’ ) );

else

RF_REG <= RF_REG_INP;

end if ;

end if ;

end process RF_SEQ ;

end generate SR_SEQ ;

-- PROCESS NUMBER 3

RF_COMB : process ( RF_REG, WENB, WADDR, WDATA )

variable RF_INDEX : integer range 0 to 2**LOG2C ( NWORDS ) - 1;

begin

RF_REG_INP <= RF_REG;
RF_INDEX := CONV_INTEGER( unsigned( WADDR ) );
if (RF_INDEX <= NWORDS - 1) then

if WENB = WEN_LOGIC_VAL(0) then

RF_REG_INP( RF_INDEX ) <= WDATA;

end if;

end if;

end process RF_COMB ;

-- PROCESS NUMBER 4

RADDR1_REG: process (CLK, N_RST)

begin -- process RADDR1_REG

if N_RST = ‘0’ then -- asynchronous reset (active
low)

RDATA1_REG <= (others => ‘0’);

elsif CLK'event and CLK = ‘1’ then -- rising clock edge

RDATA1_REG <= RDATA1_INP;

end if;

end process RADDR1_REG;

end RTLS_MUX ;

REGFILE_2OUT END

As an expert on the field can easily see from the sources of REGFILE_{—}2OUT listed above, the three “INSTANTIATED”, “ENTITY” and “ARCHITECTURE” modules allow the definition, as highlighted by comments written in bold, of generic parameters, discrete logical functions, connections, programmable register blocks, and the alternative read/write functions (multiplexer) of REGFILE_{—}2OUT 12 in order to write the register contents in the INSTR_SPLITTER 18 when addressed by DATA_COUNT 16 or to write on the CPU 30, by means of MPI_MEM_ADAPT 11, in order to check the contents of what CPU 30 wrote on REGFILE_{—}2OUT 12.

LOGIC_OPER MODULE

1] LOGIC_OPER INSERTED INTO THE PARSER ARCHITECTURE
------------------------------------------------------------------------------
-- Module: PARSER
-- VIP library (TM)
-- (C) Copyright by CSELT S.p.A 1999
-- File name: parser_strs.vhd
-- Purpose:
-- Synthesis: synthesizable
------------------------------------------------------------------------------
-- DEFINES GENERAL PARAMETERS, IN PARTICULAR WITH GENERIC PARAMETER
-- MAX_OPER THE NUMBER OF LOGICAL CIRCUITS CORRESPONDING TO THE
-- LOGIC_OPER MODULE TO BE IMPLEMENTED BY SYNTHESIS COMPILATION
CONCURR_OPER: for oper_index in 0 to MAX_OPER - 1 generate

I_LOGIC_OPER : LOGIC_OPER

generic map (

| | |
|---|---|
| NBITS | => DATA_WIDTH, |
| OUTPUT_REG | => 1 |

)

port map (

| | |
|---|---|
| CLK | => CLK, |
| RSTN | => RSTN, |
| DATA_IN | => DATA_INT, |
| DVAL_IN | => DVALID_INT, |
| MASK_PROG | => MASK_INT(DATA_WIDTH* (MAX_OPER-oper_index) - |

1 downto DATA_WIDTH* (MAX_OPER-oper_index) - DATA_WIDTH),

| | |
|---|---|
| DATA_PROG | => DATA_PROG_INT, |
| OPER_PROG | => OPER_INT(OPER_WIDTH* (MAX_OPER-oper_index) - |

1 downto OPER_WIDTH* (MAX_OPER-oper_index) - OPER_WIDTH),

| | |
|---|---|
| MASK_OUT | => MASK_CTRL(DATA_WIDTH*(MAX_OPER-oper_index) - |

1 downto DATA_WIDTH* (MAX_OPER-oper_index) - DATA_WIDTH),

| | |
|---|---|
| COMP_RESULT | => RESULT_CTRL(MAX_OPER - oper_index - 1), |
| COMP_RESULT_VALID | => RES_VAL_CTRL(MAX_OPER - oper_index - 1) |

);

end generate CONCURR_OPER;

2] LOGIC_OPER ENTITY
------------------------------------------------------------------------------
-- Module: PARSER
-- VIP library (TM)
-- (C) Copyright by CSELT S.p.A 1999
-- File name: logic_oper.vhd
-- Purpose:
-- Synthesis: synthesizable
------------------------------------------------------------------------------
library IEEE ;

use IEEE.std_logic_1164.all ;

library PACKAGES_REF;

use PACKAGES_REF.VIP_ARITH.all;

entity LOGIC_OPER is
-- PARAMETER DEFINITION

generic (

NBITS : integer := 16;

| | |
|---|---|
| OUTPUT_REG : integer := 1 | -- 0 = Combinatorial Output |
| -- 1 = Registered Output | |

) ;

-- DEFINITION OF MODULE INPUTS AND OUTPUTS

port (

CLK : in std_ulogic;
RSTN : in std_ulogic;
DATA_IN : in std_ulogic_vector ( NBITS - 1 downto 0 );
DVAL_IN : in std_ulogic ;
MASK_PROG : in std_ulogic_vector ( NBITS - 1 downto 0 );
DATA_PROG : in std_ulogic_vector ( NBITS - 1 downto 0 );
OPER_PROG : in std_ulogic_vector ( 1 downto 0 );
MASK_OUT : out std_ulogic_vector ( NBITS - 1 downto 0 );
COMP_RESULT : out std_ulogic;
COMP_RESULT_VALID : out std_ulogic

) ;

end LOGIC_OPER;
3] LOGIC_OPER ARCHITECTURE
------------------------------------------------------------------------------
-- Module: PARSER
-- VIP library (TM)
-- (C) Copyright by CSELT S.p.A 1999
-- File name: logic_oper_rtls_mux.vhd
-- Purpose:
-- Synthesis: synthesizable
------------------------------------------------------------------------------
library IEEE ;

use IEEE.std_logic_1164.all ;
use IEEE.std_logic_arith.all ;

```
architecture RTLS_MUX of LOGIC_OPER is
------------------------------------------------------------------------------
  -- OPER_PROG
  -- Bit 1 : NOT = ‘1’;
  -- Bit 0 : Equal = ‘0’; Greater Than or Equal to = ‘1’;
------------------------------------------------------------------------------
-- DEFINITION OF CONSTANTS OR SIGNALS
  constant MASK_NULL : std_ulogic_vector( NBITS - 1 downto 0 ) := (others
=> ‘0’);
  signal OPER_INT, COMP_RESULT_INT, COMP_RESULT_VALID_INT : std_ulogic ;
  signal DATA_IN_INT, DATA_PROG_INT : unsigned ( NBITS - 1 downto 0 ) ;
begin
-- DESCRIPTION OF COMBINATORY FUNCTIONS AND ASSOCIATIONS OF SIGNALS THAT
-- WILL BE IMPLEMENTED WITH DISCRETE LOGIC OR DIRECT CONNECTION
  DATA_IN_INT <= unsigned(DATA_IN and MASK_PROG);
  DATA_PROG_INT <= unsigned(DATA_PROG and MASK_PROG);
```

OPER_INT <= ‘1’ when (OPER_PROG(0) = ‘0’ and (DATA_IN_INT =

DATA_PROG_INT) or

(OPER_PROG(0)

DATA_PROG_INT) else

‘0’;

COMP_RESULT_INT <= OPER_INT when OPER_PROG(1) = ‘0’ else

not OPER_INT ;

COMP_RESULT_VALID_INT <= ‘1’ when (DVAL_IN = ‘1’ and not (MASK_PROG =
MASK_NULL)

else ‘0’;

REG_OUT_GEN: if not (OUTPUT_REG = 0) generate
-- PROCESS NUMBER 1

OUT_COMP_REG: process (CLK, RSTN)
begin -- process OUT_COMP_REG

| | |
|---|---|
| if RSTN = ‘0’ then | -- asynchronous reset (active |

low)

```
  COMP_RESULT <= ‘0’;
  COMP_RESULT_VALID <= ‘0’;
  -- DATA_OUT <= (others => ‘0’);
  MASK_OUT <= (others => ‘0’);
```

elsif CLK‘event and CLK = ‘1’ then -- rising clock edge

```
  COMP_RESULT <= COMP_RESULT_INT;
  COMP_RESULT_VALID <= COMP_RESULT_VALID_INT;
  -- DATA_OUT <= std_ulogic_vector(DATA_IN_INT) ;
  MASK_OUT <= MASK_PROG;
```

end if;

end process OUT_COMP_REG;

```
  end generate REG_OUT_GEN;
-- ASSOCIATION OF SIGNALS ALTERNATIVE TO PROCESS NUMBER 1
  COMB_OUT_GEN: if OUTPUT_REG = 0 generate
```

COMP_RESULT <= COMP_RESULT_INT;
COMP_RESULT_VALID <= DVAL_IN ;
-- DATA_OUT <= std_ulogic_vector(DATA_IN_INT);
MASK_OUT <= MASK_PROG;

end generate COMB_OUT_GEN;
end RTLS_MUX;

LOGIC_OPER END

As an expert on the field can easily see from the sources of LOGIC_OPER listed above, the three “INSTANTIATED”, “ENTITY” and “ARCHITECTURE” modules allow definition, as highlighted by comments written in bold, of generic parameters, logical functions and connections. In particular “LOGIC_OPER INSTANTIATED” makes it possible to define by means of the MAX_OPER parameter the number of circuit elements corresponding to the LOGIC_OPER 22 module obtainable by synthesis. In addition, “LOGIC_OPER ARCHITECTURE” allows definition of the programmable logical functions that the LOGIC_OPER 22 module is suitable to complete on data cell bit strings in the section “DESCRIPTION OF COMBINATORY FUNCTIONS AND ASSOCIATIONS OF SIGNALS THAT WILL BE IMPLEMENTED WITH DISCRETE LOGIC OR DIRECT CONNECTION”. Such functions are listed as an example in Table 2 hereunder.

TABLE 2

| Binary code | | Check type | Symbol |
|---|---|---|---|
| 0 | 0 | The string is equal to the value searched | = |
| 0 | 1 | The string is greater than or equal to the | >= |
| | | value searched | |
| 1 | 0 | The string is other than the value searched | ≠ |
| 1 | 1 | The string is smaller than the value | < |
| | | searched | |

Sources for modules MPI_MEM_ADAPT 11, SPEED_DECOUPLER 15, DATA_COUNT 16, INSTR_SPLITTER 18 and PARSER_CTRL 28 are not specified as they are generally known modules that do not represent characteristic features of the invention and can be easily implemented based on the knowledge of any expert on the field.

The various modules of parser module 10 are specialized in a fourth step 400 with given parameter groups (scenario of parameters), according to the values listed in Table 1 for instance. Such scenarios are repeatedly changed to perform the same number of logical simulations as the number of possible scenarios.

Zero (0) delay logical simulation is performed in a fifth step 500 for each scenario previously defined. Logical simulation can be performed with commercially available programs such as the SYNOPSIS VSS for instance. Recycling to correct module and/or parameter or constant errors are possible during this step 500. At positive step completion, 0 delay logical simulation for all possible parameter scenarios will result for parser module 10.

Initial compilation is performed in a sixth step 600, with the SYNOPSYS Design Analyzer program for instance, using a determined scenario of parameters such as one aimed at implementing a given parser circuit. Recycling is also possible in step 600 and can require some module and/or parameter or constant correction, as an expert on the field can easily understand.

Logical optimization is performed during a seventh step 700, by further use of the SYNOPSIS Design Analyzer program for instance and a library of physical components is “mapped” to the modules compiled so as to obtain actual synthesis compilation suitable to define the physical layout of the parser circuit. The output of step 700, as any expert of the field knows, can be the information required for the physical implementation of a so-called FULL CUSTOM integrated circuit, available naturally at the Vendor of physical libraries “mapped” to the compiled module (step 800), or, as an alternative, the information required for physically programming programmable components (step 900), such as Field Programmable Gate Arrays (FPGA) type components for instance.

Several programmable parser circuits suitable to perform different analysis functions on one or more protocols can therefore be obtained with this invention, by means of the flow diagram described and by using a parser 10 module according to the architecture described and specializing the modules with a given scenario of parameters.

The example below describes the operation of a parser circuit obtained according to the flow described and suitable to analyse MPEG Transport Stream cells alternately:

to control and identify the PID and extract the Program Clock Reference (PCR), a further important parameter for such protocol;

to control and identify the PID.

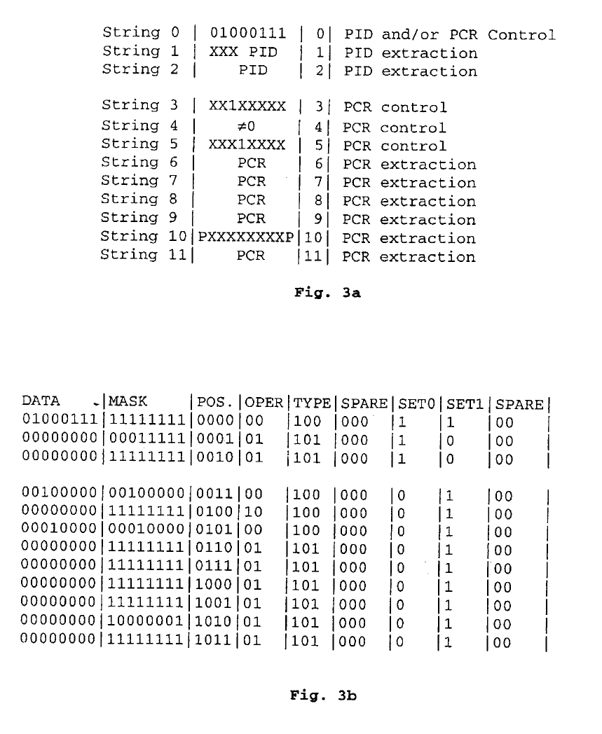

A MPEG II Transport Stream cell is characterized by the fact of containing significant PID recognition data in the first three bit strings and the significant PCR recognition data from the fourth to the twelfth bit string (FIG. 3a). In particular, string 0 contains fixed code 47 HEX, strings 1 and 2 the PID and strings from 3 to 11 the PCR. To identity and validate both the PID and the PCR, the parser circuit obtained according to the flow described and by applying a given parameter scenario for analysing MPEG II Transport Stream cells, must analyse the first twelve 8-bit strings of the MPEG II Transport Stream cell and must therefore contain 12 programming instructions (FIGS. 3a and 3b), whose width as will be described in detail hereunder is 32 bits. The width of such instructions depends on the parameter scenario identified for the protocol and can of course change according to the scenario applied and the parser circuit obtained by synthesis. In the case of a parser circuit for MPEG II Transport Stream analysis, each programming instruction contains the following significant fields, from left to right:

DATA: contains the datum to retrieve or on which a logical function is to be carried out;

MASK: indicates with bits increased to 1 the position in the bit string to retrieve DATA from or on which a logical function is to be carried out;

POS[ITION]: indicates the position of the string in the data cell and, as already specified, corresponds to the information transmitted by INST_SPLITTER 18 (FIGS. 1, 2, 3a and 3b) to DATA_COUNT 16. In the first operating example, POS has a progressive value from 0 to 11 as all the first twelve bit strings must be controlled in such example;

OPER: indicates the type of analysis to be performed on the bit string, taking account of DATA and MASK and corresponds to the values shown in Table 2.

TYPE: indicates the type of operation to perform with three bits, the first if raised indicating that the operation is mandatory, the second if raised that operations are to be performed if the first bit is 0 and the third bit if raised indicating that the datum analysed must also be retrieved; function TYPE being anyhow obtainable based on the VHDL sources listed in the description;

SET0: attributes meaning to the type of analysis performed on the bit string; in particular, the bit is 1 in the example if the type of control is attributed to PID research

SET1: attributes meaning to the type of analysis performed on the bit string; in particular, the bit is 1 in the example if the type of control is attributed to PCR research. It should be noted that in the example, control in the case of the first bit string (string 0) is necessary and to be attributed logically both to the research for PID and PCR and that the bit of both SET0 and SET1 is therefore 1.

On examining the MPEG II Transport Stream cell bit strings from top to bottom and from left to right, and the corresponding programmed instructions (FIGS. 3a and 3b) operation of the parser circuit according to the example can be understood. In the first instruction, the value 47 HEX is programmed in the DATA field; in the MASK field all 1 bits imply control on the entire string; POS “0000” indicates it is an analysis of the first cell bit string; OPER “00” indicates that the analysis is being performed by equivalence; TYPE “100” indicates a mandatory analysis the negative outcome of which implies rejection of the data cell; SET0 and SET1 “11” indicate that the analysis is functional to PID and PCR search. In the second instruction, the DATA field is set to 0 as any value can be present in this string; in the MASK field the third to the seventh bits are raised as PID is to be searched on these bits; POS “0001” indicates analysis of the second bit string; OPER “01” indicates that a value [symbol] the value in DATA must be searched; TYPE “101” indicates that analysis is mandatory and that at the string, which as already described is transmitted as a transparent output, groups of signals, such as a validation bit and MASK will also be transmitted as an output, in synchronism with the bit string; SET0 at 1 and SET1 at 0 indicate that this analysis is only significant for PID. The following instructions are based on the same logic, so no detailed explanation is believed necessary.

By means of the programmed instructions, the parser circuit can thus supply analysed bit strings as an output and also transmit groups of signals indicative of the analysis performed, when so requested by the TYPE function. The example also clearly shows that if only PID is to be analysed, 12 programming instructions are not required but the first three are enough and that the parser circuit can in this case be programmed with just these instructions. Thanks to this characteristic, the parser circuit according to the invention allows both diversified analyses to be performed with the same protocol and diversified analyses with different protocols, as can be easily understood, in particular when the parameter scenario used for implementing the circuit allows it.

As specified by the description, the parser module according to the invention is parametric and is generally independent of the width of data in cells to be analysed, is programmable and can perform several analyses in parallel and associate to data the groups of signals indicative of analyses performed.

Obvious modifications or variations are possible with respect to the description given above, to sizes, shapes, materials, components, circuit elements, connections and contacts, as well as to circuitry details and the construction as illustrated and the method of operation without departing from the principle of the invention as claimed.

1. Module (10) for generating circuits for analysing bit strings inside data cells compilable on silicon by means of a computer, comprising:
means for managing data cells (15, 16) parametrically configurable for managing variable width data cells and representative of management circuitry elements suitable to manage telecommunications data cell streams;
memory means (12) parametrically configurable and representative of storage circuitry elements suitable to store at least one programmable instruction for conditioning said analysis of bits strings inside data cells managed by said management circuitry elements; and
scenario means suitable to configure said management (15, 16) and memory (12) means with a determined scenario of parameters whereby said module compiled on silicon is suitable to generate a circuit for analysing bit strings inside telecommunications data cells in a programmable fashion.

2. Module according to claim 1, further comprising analysis means (22) parametrically configurable and representative of a maximum number between 1 and a preset number n of analisys circuitry elements which can be activated simultaneously and conditioned by at least one programmable instruction.

3. Module according to claim 1 or 2 characterized in that said memory means (12) comprises a width parameter suitable to define the width of said storage circuitry elements.

4. Module according to claim 1, 2 or 3 characterized in that said memory means (12) comprises a depth parameter suitable to define a maximum number of storage circuitry elements suitable to store a corresponding maximum number of programmable instructions.

5. Method for implementing a circuit suitable for analysing bit strings inside data cells, comprising the following steps:
A] developing and describing (300), through a programming language interpretable by a computer, a block of instructions to manage variable width data cells (15, 16) parametric and representative of circuitry elements suitable to manage telecommunications data cell streams;
B] developing and describing (300) through said language a block of instructions to store instructions (12) parametric and representative of storage circuitry elements suitable to store at least one programmable instruction to condition said bit string analysis in data cells;
C] specializing (400) the blocks as developed and described by attributing a detremined scenario of parameters to said blocks;
D] compiling on silicon (600, 700) said specialised blocks by means of the said computer so as to obtain a determined circuit suitable to analyse bit strings inside telecommunications data cells in a programmable fashion.

6. Method according to claim 5 characterized in that it further comprises the step of
E] developing and describing (300) through said language a block of instructions to analyse (22) parametric and representative of a maximum number included between 1 and a preset number n of analisys circuitry elements which can be activated simultaneously and conditioned by at least one programmable instruction to analyse bit strings inside data cells.

7. Method according to claim 5 or 6 characterized in that said step B] further comprises the step of
dimensioning said programmable instruction with a width variable within a range of preset values.

8. Method according to claim 5, 6 or 7 characterized in that said step B] further comprises the step of
dimensioning a maximum number of circuitry elements suitable to store corresponding programmable instructions.

9. Integrated circuit for analysing bit strings inside data cells comprising:
management circuitry elements suitable to manage incoming streams of telecommunications data cells;
analysis circuitry elements suitable to selectively analyse bit strings inside said incoming data cells;
characterized by
storage circuitry elements suitable to store at least one programming instruction to condition said analysis elements and in that
means are provided which co-operate with said circuit to selectively determine and store at least one programming instruction into said storage circuitry elements.

10. Integrated circuit according to claim 9 characterized in that said analysis circuitry elements are suitable to simultaneously analyse several bit strings inside said data cells.

11. Integrated circuit according to claims 9 or 10 characterized in that it is built into a programmable type integrated devices.
